(19) United States
(12) Patent Application Publication
(10) Pub. No.: US 2025/0166127 A1
(43) Pub. Date: May 22, 2025

(54) APPARATUS AND METHOD OF IMAGE PROCESSING TO ENHANCE MEMORY FEATURES IN IMAGE

(71) Applicant: Varjo Technologies Oy, Helsinki (FI)

(72) Inventors: Mikko Ollila, Tampere (FI); Ville Timonen, Helsinki (FI); Mikko Strandborg, Hangonkylä (FI)

(73) Assignee: Varjo Technologies Oy, Helsinki (FI)

(21) Appl. No.: 18/516,166

(22) Filed: Nov. 21, 2023

(51) Int. Cl. G06T 5/00; G06T 3/40

(52) U.S. Cl. CPC G06T 5/00; G06T 3/4023; G06T 3/4046; G06T 2207/10016; G06T 2207/10024; G06T 2207/20081; G06T 2207/20084

(57) ABSTRACT

Disclosed is an apparatus, including an image sensor to capture an image with a first number of pixels; execute a sub-sampling during the capture of the image to store a sub-sampled input image comprising a second number of pixels less than the first number of pixels. A processor configured to execute a pre-trained neural network model on the sub-sampled input image to detect one or more memory features in the sub-sampled input image and reconstruct missing or sub-sampled pixels corresponding to the detected one or more memory features in the sub-sampled input image; and generate an output image with enhanced one or more memory features present in a legible form.

### TECHNICAL FIELD

The present disclosure relates to apparatus for image processing. The present disclosure also relates to method of image processing.

### BACKGROUND

Nowadays, with an increase in number of images being captured every day, there is an increased demand for developments in image processing. Such a demand is quite high and critical in case of evolving technologies such as immersive extended-reality (XR) technologies.

However, existing image processing apparatuses and techniques have several limitations associated therewith. For example, the existing apparatuses and techniques exhibit high costs and increased power consumption due to complex image processing, which is undesirable. Additionally, they lack the capability to capture the entire field of view at full resolution and frame rate, often resulting in image artifacts during reconstruction. Such artifacts can lead to false image generation. Furthermore, the existing image processing apparatuses and techniques fail to maintain visual clarity, resulting in reduced image quality and discomfort, which hampers the immersive experience and may produce an undesirable outcome. Additionally, the existing image processing apparatuses struggle to adapt to users' visual acuity and perception, thereby limiting the realistic experience that the XR can offer.

Therefore, in light of the foregoing discussion, there exists a need for image processing apparatus to overcome the aforementioned drawbacks.

### SUMMARY

The aim of the present disclosure is to provide an apparatus and a method of image processing with reduced power consumption and overall cost utilization. The aim of the present disclosure is achieved by the apparatus and the method of image processing for enhancing the visual quality and comfort of XR experiences. The apparatus reconstructs one or more memory features within images, particularly in the context of capturing images with reduced pixel counts. The apparatus further used neural networks to restore the legibility of the memory features, as defined in the appended Independent claims to which reference is made. Advantageous features are set out in the appended dependent claims.

Throughout the description and claims of this specification, the words “comprise”, “include”, “have”, and “contain” and variations of these words, for example, “comprising” and “comprises”, mean “including but not limited to”, and do not exclude other components, items, Integers, or steps not explicitly disclosed also to be present. Moreover, the singular encompasses the plural unless the context otherwise requires. In particular, where the indefinite article is used, the specification is to be understood as contemplating plurality as well as singularity, unless the context requires otherwise.

### BRIEF DESCRIPTION OF THE DRAWINGS

FIG. 1 is an illustration of a block diagram of an architecture of an apparatus of image processing to enhance memory features in an image, in accordance with an embodiment of the present disclosure;

FIG. 2 illustrates steps of a method of image processing to enhance memory features in an image, in accordance with an embodiment of the present disclosure; and

FIG. 3 is an illustration of an exemplary diagram associated with the apparatus of image processing to generate an output image, in accordance with an embodiment of the present disclosure.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In a first aspect, an embodiment of the present disclosure provides an apparatus, comprising:
an image sensor to capture an image comprising a first number of pixels;
execute a sub-sampling during capture of the image to store a sub-sampled input image comprising a second number of pixels less than the first number of pixels;
a processor configured to:
   execute a pre-trained neural network model on the sub-sampled input image to detect one or more memory features in the sub-sampled input image and
   reconstruct missing or sub-sampled pixels corresponding to the detected one or more memory features in the sub-sampled input image; and
   generate an output image with enhanced one or more memory features present in a legible form.

The present disclosure provides the aforementioned apparatus that is configured to enhance the quality of extended reality (XR) experiences by utilizing sub-sampling and a pre-trained neural network. The aforementioned apparatus is configured to capture the image comprising the first number of pixels to detect and reconstruct missing or sub-sampled pixels related to specific memory features within the image accurately, thereby, generating more legible and visually appealing images. Moreover, by generating the output image through the enhanced one or more memory features, the user experience is improved significantly allowing the user to interact with the content, resulting in a more immersive and enjoyable experience. Additionally, the use of pre-trained neural network models allows for an efficient image processing with reduced processing time and processing cost, especially in real-time applications, where quick image enhancement is required to maintain the fluidity and responsiveness of the virtual environment.

In a second aspect, an embodiment of the present disclosure provides a method of image processing implemented in at least one apparatus, the method comprising:
capturing an image comprising a first number of pixels;
executing a sub-sampling during capture of the image to store a sub-sampled input image comprising a second number of pixels less than the first number of pixels;
executing a pre-trained neural network model on the sub-sampled input image to detect one or more memory features in the sub-sampled input image and to reconstruct missing or sub-sampled pixels corresponding to the detected one or more memory features in the sub-sampled input image; and
generating an output image with enhanced one or more memory features present in a legible form.

The present disclosure provides the aforementioned method that is used to enhance the quality of extended reality (XR) experiences by utilizing sub-sampling and a pre-trained neural network. The aforementioned method is used to capture the image comprising the first number of pixels so to detect and reconstruct missing or sub-sampled pixels related to specific memory features within the image accurately, thereby, generating more legible and visually appealing images. Moreover, by generating the output image by using the enhanced one or more memory features, the user experience is improved significantly allowing the user to interact with the content, resulting in a more immersive and enjoyable experience. Additionally, the aforementioned method uses the pre-trained neural network models that allows an efficient image processing with reduced processing time and processing cost, especially in real-time applications, where quick image enhancement is required to maintain the fluidity and responsiveness of the virtual environment.

Throughout the present disclosure, the term “apparatus” refers to specialized equipment that is configured to present an extended-reality (XR) environment to a user. In operation, the apparatus is worn by the user on his/her head. In such an instance, the apparatus acts as a device (for example, an XR headset, a pair of XR glasses, and the like) that is operable to present a visual scene of the XR environment to the user. Commonly, the “apparatus” is referred to as a “head-mounted display apparatus”, for the sake of convenience only. Throughout the present disclosure, the term “extended-reality” encompasses virtual reality (VR), augmented reality (AR), mixed reality (MR), and the like.

The apparatus comprises an image sensor to capture the image comprising the first number of pixels. Throughout the present disclosure, the term “image sensor” refers to a device that detects light from the real-world environment at its photo-sensitive surface when said light is incident thereupon. The image sensor comprises a plurality of photo-sensitive elements, which collectively form the photo-sensitive surface of the image sensor. Upon such detection of the light from the real-world environment, the plurality of photo-sensitive elements captures a plurality of image signals. The plurality of image signals are electrical signals pertaining to a real-world scene of the real-world environment.

The plurality of image signals are processed (by an image signal processor or the processor of the imaging apparatus) to generate a digital image. A given photo-sensitive element is known as a picture element or a pixel. Moreover, the generated image comprises the first number of pixels. In this regard, the term “first number of pixels” refers to the total number of pixels that are used to generate the digital image captured by the image sensor.

It will be appreciated that the plurality of photo-sensitive elements could be arranged in a required manner (for example, such as a rectangular two-dimensional (2D) grid, a polygonal arrangement, a circular arrangement, an elliptical arrangement, a freeform arrangement, and the like) to form the photo-sensitive surface of the image sensor. Examples of the image sensor include, but are not limited to, a charge-coupled device (CCD) image sensor and a complementary metal-oxide-semiconductor (CMOS) image sensor. The technical effect of capturing the image comprising a first number of pixels is to acquire image-related data for image processing, enabling detailed analysis and manipulation of the generated image.

Optionally, the image sensor is a video-see-through (VST) color camera sensor. In this regard, the term “VST color camera sensor” refers to a camera sensor that is configured to capture a video of the real-world environment in real time with virtual elements or information, creating a mixed-reality experience. The VST color camera sensor captures the real-world environment in full color, enabling immersive and lifelike rendering within an XR or VR environment. The technical effect of the video-see-through (VST) color camera sensor is to allow the processing of colored images and integrate virtual elements of the real-world view with reduced computational load and cost.

Throughout the present disclosure, the term “sub-sampling” refers to a so technique of reducing the amount of data in an image by omitting or downsizing certain pixels while maintaining the overall structure and content. Moreover, the execution of the sub-sampling is used to store a sub-sampled input image comprising a second number of pixels less than the first number of pixels, which includes omitting or downsizing certain pixels in a structured manner. In an implementation, a Bayer pattern that refers to a grid of color filters placed over the pixels of the image sensor can be used to perform sub-sampling. The Bayer pattern allows a single pixel to capture one of the color channels (i.e., red, green, and blue color channels) by omitting the information of another color. However, other sub-sampling techniques can also be used to perform sub-sampling without affecting the scope of the present disclosure. For example, the sampled input image that includes a partially faded old photograph of a family gathering. In such a case, the processor is configured to detect the one or more memory features in order to preserve and enhance the detected one or more memory features, such as the faces of family members or any text in the image, to make the corresponding image more legible and meaningful through the pre-trained neural network model. As a result, the technical effect of executing the sub-sampling during capture of the image to store a sub-sampled input image comprising a second number of pixels less than the first number of pixels is to recognize the one or more memory features within the image, even if the image has been reduced in size.

The term “processor” refers to a computational element that is operable to respond to and processes instructions that drive the apparatus. The processor may refer to one or more individual processors, processing devices, and various elements associated with a processing device that may be shared by other processing devices. Additionally, the one or more individual processors, processing devices, and elements are arranged in various architectures for responding to and processing the instructions that drive the processor. Examples of the processor may include but are not limited to, a hardware processor, a digital signal processor (DSP), a microprocessor, a microcontroller, a complex instruction set computing (CISC) processor, an application-specific integrated circuit (ASIC) processor, a reduced instruction set (RISC) processor, a very long instruction word (VLIW) processor, a state machine, a data processing unit, a graphics processing unit (GPU), and other processors or control circuitry.

In operation, the processor is configured to execute the pre-trained neural network model on the sub-sampled input image to detect one or more memory features in the sub-sampled input image. The term “pre-trained neural network model” corresponds to a machine learning model that has been previously trained on a large dataset of the one or more memory features to detect one or more memory features in the sub-sampled input image. In an implementation, the pre-trained neural network model is trained on the features, such as objects, shapes, textures, or any other visual elements that can be used to recognize a certain missing part of an image.

Moreover, the term “one or more memory features” refers to elements or characteristics within the input image or visual content that are related to text. The one or more memory features include components, human faces, patterns, or details in the input image that involve written or printed words, characters, symbols, or any form of textual information. The one or more memory features are present in an unreadable or distorted form. In other words, the one or more memory features are texts, which are not easily legible or recognizable due to various factors, such as poor image quality, distortion, or other forms of degradation. The unreadable form may include poor legibility, low resolution, heavy blurring, or excessive noise in the input image. The distorted form may include geometric distortions (i.e., skewed, or warped appearance of text due to viewing angles), digital or compression artifacts, and the like. Such so an unreadable or distorted form of the one or more memory features causes problems while comprehending the actual meaning conveyed through the one or more memory features. The technical effect of executing the pre-trained neural network model is to provide an accurate and reliable detection of the one or more memory features in the sub-sampled input image.

Optionally, the pre-trained neural network model is trained using transfer learning comprising:
acquire a training dataset of images captured using the sub-sampling; and
apply transfer learning by selecting a relevant pre-trained neural network model and fine-tuning the relevant pre-trained neural network model using the training dataset.

In this regard, the term “training dataset” refers to a collection of images that have been captured using the sub-sampling techniques and can be used for training the neural network to detect the one or more memory features. The training dataset is used to recognize and detect the one or more memory features with sub-sampled images more accurately and reliably. Moreover, the application of transfer learning by selecting the relevant pre-trained neural network model and fine-tuning of the relevant pre-trained neural network model using the training dataset is used to accelerate the training process and leverage the general knowledge captured by the pre-trained model. Such transfer enables the neural network to recognize various patterns, objects, or features within images with reduced computational load and computational cost. Furthermore, the fine-tuning of the relevant pre-trained neural network model using the training dataset involves adjusting the parameters of the pre-trained neural network model to ensure an accurate and reliable detection of the one or more memory features. The technical effect of pre-training the pre-defined neural network model using transfer learning is to enhance the performance of the pre-defined neural network model that can be further used for the reconstruction of sub-sampled images.

Optionally, the one or more memory features are present on a size range of 5 to 25 pixels of the sub-sampled input image.

In an example, the one or more memory features are present on the size of 5 pixels of the sub-sampled input image. In another example, the one or more memory features are present on the size of 10 pixels of the sub-sampled input image. In yet another example, the one or more memory features are present on the size of 25 pixels of the sub-sampled input image. The technical effect of the one or more memory features present on the size range of 5 to 25 pixels in a sub-sampled input image is to ensure that essential visual elements are preserved with enhanced quality, allowing for better recognition, memory, and overall user satisfaction in various applications, such as image processing and computer vision tasks.

Optionally, the one or more memory features include one or more of: letter features, familiar faces, or user interface elements or components.

In an example, the one or more memory features include letter features. In another example, the one or more memory features include familiar faces. In yet another example, the one or more memory features include user interface elements or components. In another example, the one or more memory features include letter features and familiar faces. In yet another example, the one or more memory features include letter features, familiar faces, or user interface elements or components. The technical effect of the one or more memory features that include letter features, familiar faces, or user interface elements or components, is to preserve crucial information, enhance user engagement, and facilitate effective communication and interaction in various applications, ranging from image processing to user interface design.

Optionally, the user interface elements or components are related to one or more of: control devices, mechanical devices, or display devices used in a training and simulation system.

In an example, the user interface elements or the components are related to control devices used in the training and simulation system. In another example, the user interface elements or the components are related to mechanical devices used in the training and simulation system. In yet another example, the user interface elements or the components are related to display devices used in the training and simulation system. The technical effect of integrating user interface elements related to control devices, mechanical devices, and display devices in the training and simulation system is to enhance user control, Interaction, and the overall quality of the training and simulation experience.

Optionally, the reconstruction of missing or sub-sampled pixels corresponding to the detected one or more memory features comprises employing neural filling to increase the resolution of the detected one or more memory features in the sub-sampled input image.

In this regard, the term “reconstruction of missing or sub-sampled pixels” refers to the process of restoring or recreating missing or degraded pixels that were either not captured or represented at a lower resolution. The reconstruction process is used for restoring image details and enhancing the overall quality of the image, thereby ensuring that memory features, which may have been lost or blurred due to sub-sampling, are made more legible and recognizable. Furthermore, the term “neural filling” refers to a technique that utilizes a pre-trained neural network to generate or fill in missing or degraded pixels in order to generate a visually clear image with an enhanced image resolution. The technical effect of employing neural filling to increase the resolution of detected memory features in sub-sampled images is to enhance the clarity, recognition, and memory so retention of these features, ultimately leading to an improved user experience in various applications, including image processing and computer vision tasks.

Throughout the present disclosure, the term “output image” refers to a final image that is generated by the processor in clear, readable, and visually understandable form. The processor is configured to generate an output image with enhanced one or more memory features present in a legible form. The technical effect of generating the output image with enhanced one or more memory features is to provide an image with improved quality and clarity of memory features within the output image. By enhancing the legibility of these features, users can more easily recognize and understand the content, leading to better memory retention and enhanced communication of important information. As a result, the generated output image can be particularly valuable in applications where image quality and the visibility of key elements are crucial, such as image processing, document scanning, or user interface design.

The present disclosure also relates to the method as described above. Various embodiments and variants disclosed above, with respect to the aforementioned apparatus, apply mutatis mutandis to the method.

Optionally, the reconstruction of missing or sub-sampled pixels corresponding to the detected one or more memory features comprises employing neural filling to increase the resolution of the detected one or more memory features in the sub-sampled input image.

Optionally, the one or more memory features are present on a size range of 5 to 25 pixels of the sub-sampled input image.

Optionally, the image sensor is a video-see-through (VST) color camera sensor.

Optionally, training of the pre-trained neural network model using transfer learning comprising:
acquiring a training dataset of images captured using the sub-sampling; and applying transfer learning by selecting a relevant pre-trained neural network model and fine-tuning the relevant pre-trained neural network model using the training dataset.

Optionally, the one or more memory features include one or more of: letter features, familiar faces, or user interface elements or components.

Optionally, the user interface elements or components are related to one or more of: control devices, mechanical devices, or display devices used in a training and simulation system.

### DETAILED DESCRIPTION OF THE DRAWINGS

Referring to FIG. 1, illustrated is a block diagram of an architecture of an apparatus 100 incorporating image processing to enhance memory features in an image, in accordance with an embodiment of the present disclosure. The apparatus 100 comprises a processor 102. The processor 102 is communicably coupled to an image sensor 104 that is configured to capture an image comprising the first number of pixels. The processor 102 is configured to perform various operations, as described earlier with respect to the aforementioned first aspect.

It may be understood by a person skilled in the art that FIG. 1 includes a simplified architecture of the apparatus 100, for the sake of clarity, which should not unduly limit the scope of the claims herein. It is to be understood that the specific implementation of the apparatus 100 is provided as an example and is not to be construed as limiting it to specific numbers or types of servers, display apparatuses, and congestion control network devices. The person skilled in the art will recognize many variations, alternatives, and modifications of embodiments of the present disclosure.

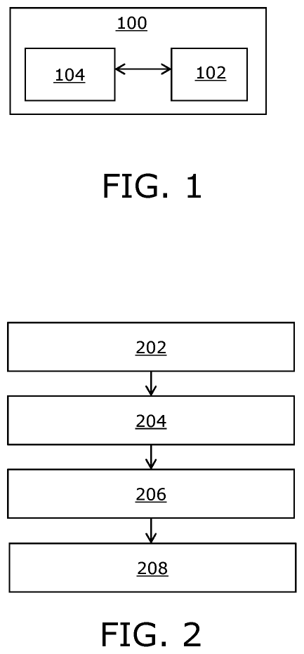

Referring to FIG. 2, illustrated are steps of a method incorporating image processing to enhance memory features in an image, in accordance with an embodiment of the present disclosure. At step 202, an image comprising the first number of pixels is captured. At step 204, a sub-sampling is executed during capture of the image to store a sub-sampled input image comprising a second number of pixels less than the first number of pixels. At step 206, a pre-trained neural network model is executed on the sub-sampled input image to detect one or more memory features in the sub-sampled input image and to reconstruct missing or sub-sampled pixels corresponding to the detected one or more memory features in the sub-sampled input image. At step 208, an output image is generated with an enhanced one or more memory features present in a legible form.

The aforementioned steps are only illustrative and other alternatives can also be provided where one or more steps are added, one or more steps are removed, or one or more steps are provided in a different sequence without departing from the scope of the claims.

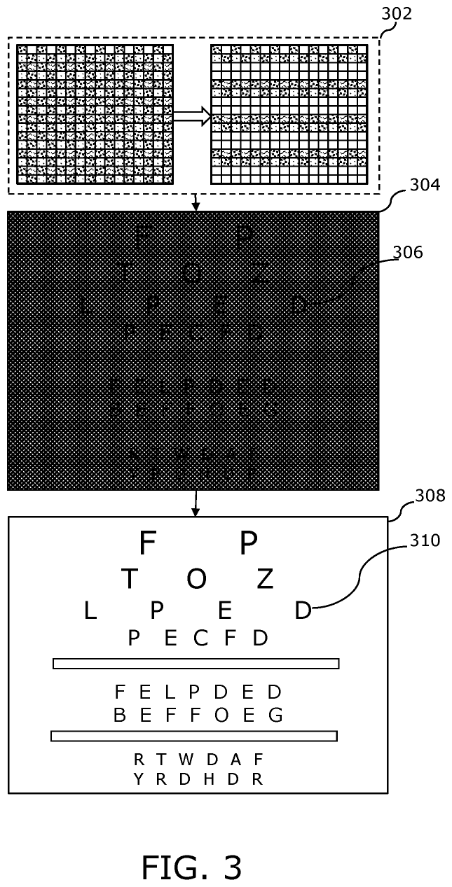

Referring to FIG. 3, illustrated is an exemplary diagram associated with the apparatus of image processing to generate an output image, in accordance with an embodiment of the present disclosure. At 302, there is shown an execution of a sub-sampling, such as by using the Bayer-pattern sub-sampling technique during the capturing of the image to store a sub-sampled input image 304 comprising a second number of pixels less than the first number of pixels. The Bayer-pattern sub-sampling refers to a sub-sampling technique in which a grid of color filters placed over the pixels can be used to perform sub-sampling. The Bayer pattern allows a single pixel to capture one of these color channels by omitting the information of the other color, as depicted by various patterns in the grid as shown in FIG. 3. In an implementation, an image sensor (i.e., the image sensor 104 of FIG. 1) is configured to capture an image comprising a first number of pixels. Furthermore, a processor (i.e., the processor 102 of FIG. 1) is configured to execute a pre-trained neural network model on the sub-sampled input image 304 to detect one or more memory features 306 in the sub-sampled input image 304. After that, the processor is configured to reconstruct missing or sub-sampled pixels corresponding to the detected one or more memory features 306 in the sub-sampled input image 304 and generate an output image 308 with enhanced one or more memory features 310 present in a legible form. As a result, the use of a pre-trained neural network model allows for an efficient image processing with reduced processing time and processing cost, especially in real-time applications, where quick image enhancement is required to maintain the fluidity and responsiveness of the virtual environment.

FIG. 3 is merely an example, which should not unduly limit the scope of the claims herein. A person skilled in the art will recognize many variations, alternatives, and modifications of embodiments of the present disclosure.

1. An apparatus, comprising:
an image sensor to capture an image comprising a first number of pixels;
execute a sub-sampling during capture of the image to store a sub-sampled input image comprising a second number of pixels less than the first number of pixels;
a processor configured to:
execute a pre-trained neural network model on the sub-sampled input image to detect one or more memory features in the sub-sampled input image and
reconstruct missing or sub-sampled pixels corresponding to the detected one or more memory features in the sub-sampled input image; and
generate an output image with enhanced one or more memory features present in a legible form.

2. The apparatus of claim 1, wherein the reconstruction of missing or sub-sampled pixels corresponding to the detected one or more memory features comprises employing neural filling to increase the resolution of the detected one or more memory features in the sub-sampled input image.

3. The apparatus of claim 1, wherein the one or more memory features are present on a size range of 5 to 25 pixels of the sub-sampled input image.

4. The apparatus of claim 1, wherein the image sensor is a video-see-through (VST) color camera sensor.

5. The apparatus of claim 1, wherein the pre-trained neural network model is trained using transfer learning comprising:
acquire a training dataset of images captured using the sub-sampling; and
apply transfer learning by selecting a relevant pre-trained neural network model and fine-tuning the relevant pre-trained neural network model using the training dataset.

6. The apparatus of claim 1, wherein the one or more memory features include one or more of: letter features, familiar faces, or user interface elements or components.

7. The apparatus of claim 6, wherein the user interface elements or components are related to one or more of: control devices, mechanical devices, or display devices used in a training and simulation system.

8. A method of image processing implemented in at least one apparatus, the method comprising:
capturing an image comprising a first number of pixels;
executing a sub-sampling during capture of the image to store a sub-sampled input image comprising a second number of pixels less than the first number of pixels;
executing a pre-trained neural network model on the sub-sampled input image to detect one or more memory features in the sub-sampled input image and to reconstruct missing or sub-sampled pixels corresponding to the detected one or more memory features in the sub-sampled input image; and
generating an output image with enhanced one or more memory features present in a legible form.

9. The method of claim 8, wherein the reconstruction of missing or sub-sampled pixels corresponding to the detected one or more memory features comprises employing neural filling to increase the resolution of the detected one or more memory features in the sub-sampled input image.

10. The method of claim 8, wherein the one or more memory features are present on a size range of 5 to 25 pixels of the sub-sampled input image.

11. The method of claim 8, wherein the image sensor is a video-see-through (VST) color camera sensor.

12. The method of claim 8, wherein training of the pre-trained neural network model using transfer learning comprising:
acquiring a training dataset of images captured using the sub-sampling-(392); and
applying transfer learning by selecting a relevant pre-trained neural network model and fine-tuning the relevant pre-trained neural network model using the training dataset.

13. The method of claim 8, wherein the one or more memory features include one or more of: letter features, familiar faces, or user interface elements or components.

14. The method of claim 13, wherein the user interface elements or components are related to one or more of: control devices, mechanical devices, or display devices used in a training and simulation system.
